(19) United States
(12) Patent Application Publication
(10) Pub. No.: US 2026/0356757 A1
(43) Pub. Date: Nov. 12, 2026

(54) GEOPOLYMERISATION MIXTURES

(71) Applicant: CLEAN RESOURCES PTE LIMITED, Singapore (SG)

(72) Inventors: Konrad SERBINOWSKI, Goleta, CA (US); Renee CHRISTENSEN, Goleta, CA (US)

(73) Assignee: CLEAN RESOURCES PTE LIMITED, Singapore (SG)

(21) Appl. No.: 19/122,391

(22) PCT Filed: Oct. 17, 2023
(86) PCT No.: PCT/GB2023/052690

§ 371 Date: Apr. 18, 2025

Related U.S. Application Data
(60) Provisional application No. 63/379,911, filed on Oct. 18, 2022.

(30) Foreign Application Priority Data
Oct. 28, 2022 (GB) 2215999.0

(51) Int. Cl. C04B 28/00; C04B 14/06; C04B 22/06

(52) U.S. Cl. CPC C04B 28/006; C04B 14/06; C04B 22/064; C04B 22/066

(57) ABSTRACT

A geopolymerisation mixture is described. The geopolymerisation mixture comprises fly ash, an alkali metal hydroxide, and a strength-enhancing additive comprising (i) calcium oxide and/or calcium hydroxide, and/or (ii) magnesium oxide and/or magnesium hydroxide wherein the strength-enhancing additive is present in an amount of 5 to 30 weight % based on the total weight of fly ash and strength-enhancing additive in the geopolymerisation mixture. Also described is a process for forming a construction material and a construction article.

### TECHNICAL FIELD

This disclosure relates to geopolymerisation mixtures, processes for forming construction materials using the geopolymerisation mixtures, and to construction materials obtainable from the geopolymerisation mixtures.

### BACKGROUND

Portland cement is a key component of conventional concrete. Conventional concrete is formed when Portland cement is mixed with water, creating a paste that binds aggregate (e.g. sand) and hardens by hydraulic reactions.

Portland cement clinker is made from raw materials, such as limestone, combined with silica sources (e.g. shale). The material is typically heated in cement kilns at temperatures in excess of 1400 °C to form clinker. Clinker is ground and mixed with gypsum to produce Portland cement.

When Portland cement is mixed with water, a hydration reaction occurs to produce calcium silicate hydrate (by cement shorthand notation: C—S—H; by chemical formula ((CaO)ₙ—(SiO)_{2y}—(H₂O)_{z})) and lime (also known as portlandite) (Ca(OH)₂). C—S—H is the primary gel phase that, together with other hydration products, acts as the glue that binds the aggregates, giving cohesion to the mortar or concrete material. C—S—H is the primary phase responsible for cement's mechanical properties and durability. The stoichiometry of C—S—H in cement/water mixtures is variable.

Portland cement manufacture is a significant contributor to greenhouse gas emissions. This can occur directly through the production of carbon dioxide when the calcium carbonate (e.g. limestone) is thermally decomposed, as well as indirectly through the use of energy, particularly from the combustion of fossil fuels. In recent years, efforts have been made to reduce the carbon footprint associated with the manufacture and use of Portland cement.

One way of reducing the use of Portland cement, and subsequently greenhouse gas emissions, is to replace some of the Portland cement utilised in the production of concrete with fly ash. Fly ash is produced from the burning of pulverised coal in boilers. It is a fine, non-combustible particulate matter that is carried in the flue gases. Fly ash may be captured from flue gases by electrostatic precipitators or other particle filtration equipment. The precise composition of fly ash can vary depending upon the source of the coal being burned. In general, however, the components of fly ash include silicate, aluminate, iron and calcium phases.

The silica components of the fly ash can react with lime produced from the hydration of Portland cement to produce additional C—S—H binder, hence act as a supplementary cementing material (SCM). As well as providing environmental benefits, the partial substitution of cement binder with fly ash can also improve the mechanical properties of the hardened concrete through additional hydration reactions. To date, however, not all types of fly ash can be used for concrete applications due to the particle size, contamination with carbon residues or poor reactivity.

Geopolymers are another class of binders and are ceramic-like inorganic polymers. Unlike Portland cement, geopolymers are formed of chains or networks of mineral molecules linked by covalent bonds. Geopolymers can be formed of molecular units based on, for example, poly(siloxo), poly(sialate), poly(sialate-siloxo), poly(sialate-disiloxo) or poly-silicone chains.

Certain types of fly ash can form geopolymers in the presence of alkalis (e.g., sodium hydroxide). In the presence of such alkalis, aluminosilicates in the fly ash can decompose and subsequently polymerise by polycondensation to form a fly ash geopolymer. A geopolymer binder can subsequently be used as a substitute for Portland cement to bind aggregates and form mortar or concrete.

### DESCRIPTION

According to an aspect of the present disclosure, there is provided a geopolymerisation mixture comprising fly ash, an alkali metal hydroxide and a strength-enhancing additive comprising (i) calcium oxide and/or calcium hydroxide, and/or (ii) magnesium oxide and/or hydroxide; wherein the strength-enhancing additive is present in an amount of 5 to 40 weight % based on the total weight of fly ash and strength-enhancing additive in the geopolymerisation mixture.

The geopolymerisation mixture may comprise less than 30 weight % of Portland cement, preferably less than 20 weight %, more preferably less than 10 weight %, yet more preferably less than 5 weight % or 1 weight % Portland cement. Preferably, the geopolymerisation mixture is substantially free of Portland cement.

According to a further aspect, there is provided a process for forming a construction material, said process comprising geopolymerisation of a mixture as described herein, and curing the mixture.

In yet another aspect, there is provided a construction article obtainable by geopolymerisation of a mixture as described herein.

In the present disclosure, a strength-enhancing additive comprising (i) calcium oxide and/or calcium hydroxide, and/or (ii) magnesium oxide and/or hydroxide is included in the geopolymerisation mixture to enhance the compressive strength of the geopolymerised mixture. It has been found that such strength-enhancing additives provide improvements in compressive strength over other sources of e.g. calcium, such as gypsum and calcium carbonate. Furthermore, by using the additive in amounts of 5 to 40 weight % on the total weight of fly ash plus strength-enhancing additive, desirable compressive strengths can be obtained, particularly with poorly reactive fly ashes.

As mentioned above, fly ash is produced from the burning of pulverised coal in boilers. It is a fine, non-combustible particulate matter that is carried in the flue gases. Fly ash may be captured from flue gases by electrostatic precipitators or other particle filtration equipment. The precise composition of fly ash can vary depending upon the source of the coal being burned. In general, however, the principal components of fly ash include silica (SiO₂), alumina (Al₂O₃) and calcium oxide (CaO).

According to the American Society for Testing and Materials standard C 618 (ASTM C618-19, 2019), certain fly ashes can be classified as Class C and Class F types based on their calcium, silica and alumina contents. Class C fly ash has a high calcium content. Class C fly ash has a total SiO₂, Al₂O₃ and Fe₂O₃ content greater than 50 weight % and CaO content more than 18 weight. %. Class F fly ash has a lower calcium content. Class F fly ash has a total SiO₂, Al₂O₃ and Fe₂O₃ content greater than 50 weight % and CaO content less than or equal to 18 weight %.

In some embodiments, the Class C fly ash may have a CaO content of more than 18 weight %, preferably at least 20 weight %, more preferably 20 to 40 weight %, yet more preferably 21 to 30 weight %. The Class C fly ash may have an SiO₂ content of 45 weight % or less, preferably 20 to 43 weight %, more preferably 30 to 42 weight %. The Class C fly ash may have an Al₂O₃ content of 21 weight % or less, preferably 12 to 20 weight %, preferably 15 to 20 weight %. The Class C fly ash may have an MgO content of 4 weight % or more, preferably more than 4.5 weight %, more preferably 5 to 8 weight %, for example, 5 to 7 weight %. The Class C fly ash may have a Fe₂O₃ content of 3 weight % or more, preferably 3 to 10 weight %, more preferably 4 to 7 weight %.

The Class C fly ash may comprise SiO₂ in an amount of less than 45 weight % and CaO in an amount of more than 18 weight %. Preferably, the Class C fly ash may comprise SiO₂ in an amount of less than 45 weight % and CaO in an amount of at least 20 weight %. More preferably, the Class C fly ash may comprise SiO₂ in an amount of less than 43 weight % and CaO in an amount of at least 20 weight %.

The Class C fly ash may comprise SiO₂ in an amount of 30 to 43 weight % and CaO in an amount of 20 to 40 weight %. The Class C fly ash may comprise SiO₂ in an amount of 30 to 43 weight % and CaO in an amount of 20 to 35 weight %.

In some embodiments, the Class F fly ash may have a CaO content of 18 weight % or less, preferably 15 weight % or less, more preferably 12 weight % or less, even more preferably 10 weight % or less, yet more preferably 8 or 7 weight or less. The Class F fly ash may have a CaO content of 0.5 to 18 weight %, preferably 1 to 15 weight %, more preferably 2 to 12 weight %, even more preferably 3 to 10 weight %, yet more preferably 4 to 8 or 4 to 7 weight %. The Class F fly ash may have an SiO₂ content of more than 43 weight %, preferably 44 weight % or more, more preferably 45 weight % or more, for example, 50 weight % or more or 55 weight % or more. The Class F fly ash may have an SiO₂ content of from 43 to 70 weight %, preferably 44 to 65 weight %, more preferably 45 to 63 weight %, for example, 50 to 60 weight % or 55 to 60 weight %. The Class F fly ash may have an Al₂O₃ content of 20 to 28 weight %, preferably 21 to 25 weight %. The Class F fly ash may have an MgO content of less than 4 weight %, preferably less than 3 weight %, for example, less than 2.5 weight %. The Class F fly ash may have an MgO content of 0.5 to 4 weight %, preferably 1 to 3 weight %, for example, 1.5 to 2.5 weight %. The Class F fly ash may have a Fe₂O₃ content of 3 weight % or more, preferably 3 to 10 weight.

The Class F fly ash may comprise SiO₂ in an amount of more than 43 weight % and CaO in an amount of 18 weight % or less. Preferably, the Class C fly ash may comprise SiO₂ in an amount of more than 43 weight % and CaO in an amount of 15 weight % or less, more preferably 12 weight % or less, even more preferably 10 weight % or less, yet more preferably 8 or 7 weight or less. The Class F fly ash may comprise SiO₂ in an amount of more than 43 weight % and CaO in an amount of 0.5 to 18 weight %, preferably 1 to 15 weight %, more preferably 2 to 12 weight %, even more preferably 3 to 10 weight %, yet more preferably 4 to 8 or 4 to 7 weight %. The Class F fly ash may comprise SiO₂ in an amount of at least 50 weight % and CaO in an amount of 0.5 to 18 weight %, preferably 1 to 15 weight %, more preferably 2 to 12 weight %, even more preferably 3 to 10 weight %, yet more preferably 4 to 8 or 4 to 7 weight %. The Class F fly ash may comprise SiO₂ in an amount of 50 to 65 weight % and CaO in an amount of 3 to 10 weight %. The Class F fly ash may also have an MgO content of less than 4 weight %, preferably less than 3 weight %, for example, less than 2.5 weight %. For example, the Class F fly ash may also have an MgO content of 0.5 to 4 weight %, preferably 1 to 3 weight %, for example, 1.5 to 2.5 weight %.

The chemical composition of fly ash can be influenced by the chemical composition of the coal burned (e.g. anthracite, bituminous, sub-bituminous and lignite). Class F ash may be formed when “older” anthracite and bituminous coal is burned. Class C fly ash may be formed when “younger” lignite is burned.

Fly ash that does not conform to ASTM, EN or other norms may also be cleaned up or beneficiated to meet certain requirements. For example, the beneficiation of fly ash can remove carbon from the fly ash. It can be possible to beneficiate fly ash to alter its composition, and/or physical characteristics, and/or moisture content to meet the requirements of the ASTM C618 Class F or Class C standards.

In the present disclosure, fly ash that does not meet the ASTM C618 Class F or Class C standards is termed non-conforming fly ash. Non-conforming fly ash may be unbeneficiated fly ash, i.e. fly ash that has not been beneficiated. In some embodiments, the non-conforming fly ash may be raw (fresh) fly ash (e.g. freshly collected from flue gases) or fly ash that has been reclaimed from landfills, ponds, or other impoundments. Impounded ash may include other types of ash in addition to fly ash. For example, impounded ash may also include bottom ash. Bottom ash is typically part of the non-combustible residue of coal combustion in a e.g. a power plant, boiler, furnace or incinerator. Bottom ash may comprise combustibles embedded in forming clinkers and sticking to hot size walls of coal-burning furnaces during operation. Bottom ash differs from fly ash, as the latter is carried in the flue gases from coal combustion.

The non-conforming fly ash may have a CaO content of 18 weight % or less, preferably 15 weight % or less, more preferably 12 weight % or less, even more preferably 10 weight % or less, yet more preferably 8 or 7 weight or less. The non-conforming fly ash may have a CaO content of 0.5 to 18 weight %, preferably 1 to 15 weight %, more preferably 2 to 12 weight %, even more preferably 3 to 10 weight %. The non-conforming fly ash may have an SiO₂ content of more than 25 weight %, preferably 35 weight % or more, more preferably 40 weight %. The non-conforming fly ash may have an SiO₂ content of from 25 to 70 weight %, preferably 35 to 65 weight %, more preferably 40 to 63 weight %. The non-conforming fly ash may have an Al₂O₃ content of 10 to 35 weight %. The non-conforming fly ash may have an MgO content of less than 6 weight %. The non-conforming fly ash may have an MgO content of 0.5 to 6 weight %. The non-conforming fly ash may have a Fe₂O₃ content of 0 to 10 weight.

The non-conforming fly ash may comprise SiO₂ in an amount of more than 25 weight % and CaO in an amount of 18 weight % or less. Preferably, the non-conforming fly ash may comprise SiO₂ in an amount of more than 25 weight % and CaO in an amount of 15 weight % or less, more preferably 12 weight % or less, even more preferably 10 weight % or less, yet more preferably 8 or 7 weight or less. The non-conforming fly ash may have a CaO content of 0.5 to 18 weight %, preferably 1 to 15 weight %, more preferably 2 to 12 weight %, even more preferably 3 to 10 weight %. In a preferred embodiment of the present disclosure, the strength-enhancing additive is added to a fly ash (i.e. starting fly ash) that is not a Class C fly ash. The starting fly ash may be a Class F fly ash or a non-conforming fly ash. Thus, the strength-enhancing additive may be added to a Class F fly ash or a non-conforming fly ash. Examples of non-conforming fly ash may be unbeneficiated fly ash. The non-conforming fly ash may be raw fly ash or fly ash that has been reclaimed from landfills, ponds, or other impoundments.

Preferably, the starting fly ash has a CaO content of 18 weight % or less, preferably 15 weight % or less, more preferably 12 weight % or less, even more preferably 10 weight % or less, yet more preferably 8 or 7 weight or less. The starting fly ash may have a CaO content of 0.5 to 18 weight %, preferably 1 to 15 weight %, more preferably 2 to 12 weight %, even more preferably 3 to 10 weight %. The starting fly ash may also have a SiO₂ content of more than 25 weight %, preferably 35 weight % or more, more preferably 40 weight %. The starting fly ash may have an SiO₂ content of from 25 to 70 weight %, preferably 35 to 65 weight %, more preferably 40 to 63 weight %.

The starting fly ash has a CaO content of 18 weight % or less, preferably 15 weight % or less, more preferably 12 weight % or less, even more preferably 10 weight % or less, yet more preferably 8 or 7 weight or less, and a SiO₂ content of more than 25 weight %, preferably 35 weight % or more, more preferably 40 weight %.

The starting fly ash has a CaO content of 0.5 to 18 weight %, preferably 1 to 15 weight %, more preferably 2 to 12 weight %, even more preferably 3 to 10 weight %, and a SiO₂ content of 25 to 70 weight %, preferably 35 to 65 weight %, more preferably 40 to 63 weight %.

In the present disclosure, the compressive strength of wet-cast and/or dry-cast products formed using geopolymerisation mixtures comprising the starting fly ash can be enhanced by the addition of the strength-enhancing additive. The strength-enhancing additive can be used to “upgrade” the performance of fly ashes, such as Class F fly ash and/or non-conforming fly ash that would not normally be expected to perform as well as fly ashes, such as Class C fly ashes. The strength-enhancing additive may also permit lower amounts of activator (e.g. alkali metal hydroxide) to be used, while still achieving desirable compressive strengths. Alternatively or additionally, cure times and/or cure temperatures may also be reduced, while still maintaining desirable compressive strengths.

In a preferred embodiment of the present disclosure, the strength-enhancing additive is added to a fly ash (i.e. starting fly ash) that comprises less than 15 weight %, for example, less than 10 weight % calcium oxide. The strength-enhancing additive may be added to a fly ash that comprises 1 to 10 weight % calcium oxide, for example, 2 to 8 weight % or 3 to 7 weight % calcium oxide.

The strength-enhancing additive has a composition that differs from the composition of the fly ash to which the strength-enhancing additive is added. In other words, the strength-enhancing additive has a composition that differs from the composition of the starting fly ash. The strength-enhancing additive may be added to enhance the compressive strength of the resulting geopolymer relative to the compressive strength that would otherwise have been achievable in the absence of the strength-enhancing additive.

The strength-enhancing additive may comprise calcium oxide and at least one of silica, alumina and magnesium oxide. The strength-enhancing additive may comprise calcium oxide and silica. The strength-enhancing additive may comprise calcium oxide and silica and, optionally, magnesium oxide. Where the strength-enhancing additive comprises alumina, alumina may be present in an amount of less than 10 weight %, preferably less than 9 weight %, for example, less than 7 weight % of the total weight of the additive.

The strength-enhancing additive may comprise calcium oxide in an amount of at least 30 weight % or 40 weight % of the total weight of the additive. Calcium oxide may be present in an amount of 30 to 70 weight % or 40 to 70 weight %, for example, 50 to 60 weight % of the total weight of the additive. In addition to calcium oxide, the strength-enhancing additive may comprise silica. Silica may be present in an amount of 0.5 to 40 weight %, for example, 0.5 to 35 weight %, for instance, 10 to 30 weight %. In addition to calcium oxide and, where present, silica, the strength-enhancing additive may comprise alumina. Alumina may be present in an amount of 0 to 10 weight %, for example, 0.5 to 6 weight %.

The strength-enhancing additive may comprise calcium oxide in an amount of 30 to 70 weight % or 40 to 70 weight %, for example, 50 to 60 weight % of the total weight of the additive, and silica in an amount of 0.5 to 40 weight %, for example, 0.5 to 35 weight %, for instance, 10 to 30 weight % of the total weight of the additive.

The strength-enhancing additive may comprise (i) calcium oxide and/or hydroxide and (ii) magnesium oxide and/or hydroxide.

In some embodiments the weight ratio of (i) calcium oxide and/or hydroxide to (ii) magnesium oxide and/or hydroxide in the strength-enhancing additive may be 0.1:1 to 10:1, preferably 0.5:1 to 8:1, more preferably 0.8:1 to 6:1, for example, 1:1 to 5:1.

In some embodiments the weight ratio of (i) calcium oxide to (ii) magnesium oxide in the strength-enhancing additive may be 0.1:1 to 10:1, preferably 0.5:1 to 8:1, more preferably 0.8:1 to 6:1, for example, 1:1 to 5:1.

In some embodiments, the strength-enhancing additive may further comprise aluminium oxide and/or aluminium hydroxide in addition to calcium oxide/calcium hydroxide The strength-enhancing additive may comprise (i) calcium oxide and/or hydroxide and (iii) aluminium oxide and/or aluminium hydroxide. The strength-enhancing additive may comprise (ii) magnesium oxide and/or hydroxide and (iii) aluminium oxide and/or aluminium hydroxide. Preferably, the strength-enhancing additive may comprise (i) calcium oxide and/or hydroxide, (ii) magnesium oxide and/or hydroxide and (iii) aluminium oxide and/or aluminium hydroxide.

Where the strength-enhancing additive comprises (i) calcium oxide and/or hydroxide and (iii) aluminium oxide and/or aluminium hydroxide, the weight ratio of (i) calcium oxide and/or hydroxide to (iii) aluminium oxide and/or aluminium hydroxide may be 0.5:1 to 5:1, for example, 0.8:1 to 3:1. Alternatively, the weight ratio may be greater than 30:1, for example, greater than 50:1.

Where the strength-enhancing additive comprises (ii) magnesium oxide and/or hydroxide and (iii) aluminium oxide and/or aluminium hydroxide, the weight ratio of (ii) magnesium oxide and/or hydroxide to (iii) aluminium oxide and/or aluminium hydroxide may be 0.1:1 to 3:1, for example, 0.2:1 to 2.5:1. Alternatively, the weight ratio may be greater than 30:1, for example, greater than 50:1.

In some embodiments, the strength-enhancing additive may further comprise (iv) silica. The strength-enhancing additive may comprise (i) calcium oxide and/or hydroxide and (iv) silica. The strength-enhancing additive may comprise (ii) magnesium oxide and/or hydroxide and (iv) silica. Preferably, the strength-enhancing additive may comprise (i) calcium oxide and/or hydroxide, (ii) magnesium oxide and/or hydroxide and (iv) silica.

Where the strength-enhancing additive comprises (i) calcium oxide and/or hydroxide and (iv) silica, the weight ratio of (i) calcium oxide and/or hydroxide to (iv) silica may be 0.3:1 to 5:1, for example, 0.5:1 to 3:1 or 0.6:1 to 2:1. Alternatively, the weight ratio may be greater than 30:1, for example, greater than 50:1.

Where the strength-enhancing additive comprises (ii) magnesium oxide and/or hydroxide and (iv) silica, the weight ratio of (ii) magnesium oxide and/or hydroxide to (iv) silica may be 0.1:1 to 1:1, for example, 0.2:1 to 0.5:1. Alternatively, the weight ratio may be greater than 30:1, for example, greater than 50:1.

The strength-enhancing additive may comprise at least 20 weight % calcium oxide and/or hydroxide, for example, 20 to 60 weight % calcium oxide and/or hydroxide. In some embodiments, the strength-enhancing additive may comprise 20 to 50 weight %, preferably, 20 to 40 weight %, for example, 20 to 30 weight % calcium oxide and/or hydroxide.

The strength-enhancing additive may comprise at least 1 weight % magnesium oxide and/or hydroxide, for example, 1 to 60 weight % magnesium oxide and/or hydroxide.

In some embodiments, the strength-enhancing additive may comprise 1 to 10 weight %, for magnesium oxide and/or hydroxide.

In some embodiments, the strength-enhancing additive comprises 20 to 40 weight % calcium oxide and/or hydroxide and 1 to 10 weight % magnesium oxide and/or hydroxide.

In some embodiments, the strength-enhancing additive comprises 40 to 60 weight % calcium oxide and/or hydroxide and 40 to 60 weight % magnesium oxide and/or hydroxide.

The strength-enhancing additive may further comprise 0.5 to 25 weight % aluminium oxide and/or hydroxide. In some embodiments, the strength-enhancing additive may further comprise 12 to 25 weight % aluminium oxide and/or hydroxide. In some embodiments, the strength-enhancing additive may further comprise 0.5 to 2 weight % aluminium oxide and/or hydroxide.

In some embodiments, the strength-enhancing additive comprises at least one of (i) calcium oxide and/or hydroxide and (ii) magnesium oxide and/or hydroxide, and at least one of (iii) aluminium oxide and/or hydroxide and (iv) silica.

In some embodiments, the strength-enhancing additive comprises (i) calcium oxide and/or hydroxide and (ii) magnesium oxide and/or hydroxide, and at least one of (iii) aluminium oxide and/or hydroxide and (iv) silica.

In some embodiments, the strength-enhancing additive comprises (i) calcium oxide and/or hydroxide and (ii) magnesium oxide and/or hydroxide, and (iii) aluminium oxide and/or hydroxide.

In some embodiments, the strength-enhancing additive comprises (i) calcium oxide and/or hydroxide and (ii) magnesium oxide and/or hydroxide, and (iv) silica.

In some embodiments, the strength-enhancing additive comprises (i) calcium oxide and/or hydroxide and (ii) magnesium oxide and/or hydroxide, and (iii) aluminium oxide and/or hydroxide and (iv) silica.

The strength-enhancing additive may be selected from a dolomitic S-type lime (ASTM C207-18, 2018), Class C fly ash, cement kiln dust (CKD), ordinary Portland cement (OPC) and slag. Preferably, the strength-enhancing additive is selected from a dolomitic S-type lime (ASTM C207-18, 2018), Class C fly ash, and cement kiln dust (CKD). When the strength-enhancing additive is Class C fly ash, this strength-enhancing additive is added to fly ash that is not a Class C fly ash.

As mentioned above, the starting fly ash is preferably not a Class C fly ash but a Class F or non-conforming fly ash. The starting fly ash may have a CaO content of 18 weight % or less, preferably 15 weight % or less, more preferably 12 weight % or less, even more preferably 10 weight % or less, yet more preferably 8 or 7 weight or less. The starting fly ash may have a CaO content of 0.5 to 18 weight %, preferably 1 to 15 weight %, more preferably 2 to 12 weight %, even more preferably 3 to 10 weight %. The starting fly ash may also have a SiO₂ content of more than 25 weight %, preferably 35 weight % or more, more preferably 40 weight %. The starting fly ash may have an SiO₂ content of from 25 to 70 weight %, preferably 35 to 65 weight %, more preferably 40 to 63 weight %.

Where slag is used as the strength-enhancing additive, the slag may be a ground granulated blast furnace slag (GGBS). GGBS is a by-product of blast furnace iron production. GGBS may be designated as ASTM C 989. The slag may comprise silicates and aluminosilicates of calcium. GGBS may be classified according to increasing reactivity as Grades 80, 100 and 120. The precise composition of GGBS may depend on the raw materials used in the production of iron. Generally, the GGBS may include calcium oxide, aluminium oxide, silica and magnesium oxide. An example of a GGBS comprises 31.3 weight % silica, 32.4 weight % calcium oxide, 16.5 weight % alumina and 11.0 weight % magnesium oxide.

The strength-enhancing additive is present in an amount of 5 to 40 weight % based on the total weight of (starting) fly ash and strength-enhancing additive in the geopolymerisation mixture. If the strength-enhancing additive contains a fly ash, the fly ash component of the strength-enhancing additive is accounted for as part of the strength-enhancing additive (and not the starting fly ash). For example, if 15 g of a strength-enhancing additive consisting of a Class C fly ash is added to 85 g of a Class F fly ash, the amount of the strength-enhancing additive should be considered as 15 weight % of the total weight of the (starting) Class F fly ash and added strength-enhancing additive in the geopolymerisation mixture. Similarly, if 15 g of a strength-enhancing additive consisting of a Class C fly ash is added to 85 g of a non-conforming fly ash, the amount of the strength-enhancing additive should be considered as 15 weight % of the total weight of the starting fly ash and added strength-enhancing additive in the geopolymerisation mixture.

Preferably, the geopolymerisation mixture comprises 8 to 35 weight %, more preferably 10 to 30 weight % of the strength-enhancing additive based on the total amount of fly ash and strength-enhancing additive in the geopolymerisation mixture. Yet more preferably the amount of strength-enhancing additive added to the geopolymerisation mixture forms 12 to 25 weight % or 15 to 20 weight % based on the total weight of the fly ash and added strength-enhancing additive.

In some embodiments, the geopolymerisation mixture comprises 5 to 40 weight %, more preferably 10 to 30%, even more preferably 12 to 25 weight % of S-type lime.

In some embodiments, the geopolymerisation mixture comprises 5 to 40 weight %, more preferably 10 to 30%, even more preferably 12 to 25 weight % of Class C fly ash.

In some embodiments, the geopolymerisation mixture comprises 5 to 40 weight %, more preferably 10 to 30%, even more preferably 12 to 25 weight % of ground granulated blast furnace slag (GGBS). In some embodiments, the strength-enhancing additive is not a ground granulated blast furnace slag (GGBS). However, if GGBS is used, the GGBS may be used in an amount of 10 to 30 weight %, preferably 11 to 25 weight %, more preferably 12 to 18 weight % based on the total weight of the ground granulated blast furnace slag and the starting fly ash.

The geopolymerisation mixture may comprise a) fly ash, b) an alkali metal hydroxide, and c) the strength-enhancing, wherein the strength-enhancing additive is present in an amount of 5 to 30 weight % based on the total weight of fly ash (a) and strength-enhancing additive (c) in the geopolymerisation mixture, and wherein, where the strength-enhancing additive (c) comprises fly ash, the composition of the fly ash (c) is different from the composition of the fly ash (a) (i.e. the starting fly ash).

The geopolymerisation mixture may comprise a) fly ash, b) an alkali metal hydroxide, and c) the strength-enhancing, wherein the strength-enhancing additive is present in an amount of 5 to 30 weight % based on the total weight of fly ash (a) and strength-enhancing additive (c) in the geopolymerisation mixture, and wherein, where the strength-enhancing additive (c) is a Class C fly ash, the fly ash (c) not a Class C fly ash (i.e. the starting fly ash is not a Class C fly ash).

The geopolymerisation mixture may comprise a) fly ash, b) an alkali metal hydroxide, and c) a strength-enhancing additive selected from a dolomitic S-type lime (ASTM C207-18, 2018), Class C fly ash and slag, wherein the fly ash (a) (i.e. the starting fly ash) is not a Class C fly ash, and wherein the strength-enhancing additive is present in an amount of 5 to 30 weight % based on the total weight of fly ash (a) and strength-enhancing additive (c) in the geopolymerisation mixture.

The geopolymerisation mixture may comprise a) fly ash, b) an alkali metal hydroxide, and c) a strength-enhancing additive selected from a dolomitic S-type lime (ASTM C207-18, 2018), Class C fly ash and slag, wherein the fly ash (a) (i.e. the starting fly ash) is a Class F fly ash or a non-conforming fly ash, and wherein the strength-enhancing additive is present in an amount of 5 to 30 weight % based on the total weight of fly ash (a) and strength-enhancing additive (c) in the geopolymerisation mixture.

In some embodiments, the geopolymerisation mixture may comprise a) fly ash, b) an alkali metal hydroxide, and c) a strength-enhancing additive selected from a dolomitic S-type lime (ASTM C207-18, 2018), Class C fly ash and slag, wherein the fly ash (a) (i.e. the starting fly ash) is a Class F fly ash, an unbeneficiated fly ash and/or an impounded fly ash, and wherein the strength-enhancing additive is present in an amount of 5 to 30 weight % based on the total weight of fly ash (a) and strength-enhancing additive (c) in the geopolymerisation mixture.

In a preferred embodiment, there is provided a geopolymerisation mixture comprising a fly ash comprising
fly ash comprising calcium oxide in an amount of 18 weight % or less, preferably 15 weight % or less, more preferably 10 weight % or less;
an alkali metal hydroxide, and
a strength-enhancing additive, wherein the strength-enhancing additive is present in an amount of 5 to 30 weight % based on the total weight of fly ash and strength-enhancing additive in the geopolymerisation mixture, and
wherein the strength-enhancing additive comprises calcium oxide and at least one of silica, alumina and magnesium oxide, said calcium oxide being present in an amount of at least 30 weight %, preferably 30 to 60 weight %, based on the total weight of the strength-enhancing additive.

The geopolymerisation mixture may be obtainable by mixing
fly ash comprising calcium oxide in an amount of 18 weight % or less, preferably 15 weight % or less, more preferably 10 weight % or less;
an alkali metal hydroxide, and
a strength-enhancing additive, wherein the strength-enhancing additive is present in an amount of 5 to 30 weight % based on the total weight of fly ash and strength-enhancing additive in the geopolymerisation mixture, and
wherein the strength-enhancing additive comprises calcium oxide and at least one of silica, alumina and magnesium oxide, said calcium oxide being present in an amount of at least 30 weight %, preferably 30 to 60 weight %, based on the total weight of the strength-enhancing additive.

The strength-enhancing additive may be Class C fly ash, ground granulated blast furnace slag, S-type lime, cement kiln dust and or ordinary Portland cement. Where the strength-enhancing additive is a ground granulated blast furnace slag (GGBS), the amount of GGBS is preferably 11 to 18 weight % of the total weight of the total weight of fly ash and strength-enhancing additive in the geopolymerisation mixture.

The geopolymerisation mixture can further comprise aggregate. The aggregate may be sand, gravel and/or rubble. The aggregate content can range from 0 to 90 weight percent on geopolymerization mixture.

The geopolymerisation mixture may include alkali metal hydroxide in an amount of 3 to 20 weight % based on the total amount of fly ash to which the strength-enhancing additive is added. For example, where the starting fly ash is a Class F and/or non-conforming fly ash, the amount of alkali metal hydroxide may be 3 to 20 weight % based on the amount of Class F and/or non-conforming fly ash in the geopolymerisation mixture.

The alkali metal hydroxide may be a hydroxide of sodium calcium or potassium, preferably, sodium hydroxide.

The geopolymerisation mixture can include water, in addition to the fly ash, aggregates, alkali activator, strength-enhancing additive and other ingredients. The water content can range from 3% to 20 weight % of the mortar or concrete.

The geopolymerisation mixture may be cured at temperatures ranging from 20 to 150 degrees C. The rate of compressive strength development is increased with increasing curing temperatures. Preferably, the curing temperature is 70 to 130 degrees C.

The mixture can be moulded into a construction article prior to curing using either a wet cast or dry cast process. Examples of construction articles are paver stones, masonry blocks, cultured stone or veneer, pipes, vaults, roof tiles or any other preformed shape.

In some examples, the mixture is moulded by dry casting. With dry casting, the mixture may be placed and compacted into a mould. Following compaction, the moulded mixture may be removed from the mould, allowing the mould to be re-used prior to completion of the curing process. With dry casting, the composition may comprise less than 10 weight % water, for example, 2 to 8 weight % or 4 to 6 weight % water.

In some examples, the mixture may be moulded by wet-casting. With wet casting, the mixture may be cured in the mould.

Once geopolymerised and cured for an adequate period, the mixture may have a compressive strength of at least 5 MPa, preferably at least 10 MPa, more preferably at least 20 MPa, even more preferably at least 30 MPa.

Where the strength-enhancing additive is added to non-conforming fly ash (e.g. unbeneficiated fly ash), the geopolymerised mixture may have a compressive strength of at least 6 MPa, for example, 7 to 15 MPa. Without the strength-enhancing additive, the geopolymerised mixture may only achieve 1 to 5 MPa after curing for days at elevated temperatures.

Where the strength-enhancing additive is added to Class F fly ash, the geopolymerised mixture may have a compressive strength of at least 20 MPa, for example, 25 to 40 MPa. Without the strength-enhancing additive, the geopolymerised mixture may only achieve 15 to 20 MPa after curing for days at elevated temperatures.

### EXAMPLES

All examples are based upon the average compressive strength results of six 5 cm cubes.

### Example 1

In this Example, fly ash mortar compositions were formed by mixing 6000 g of concrete sand, 4000 g binder, 1350 g of 10M sodium hydroxide and 250 g of added water. The binder compositions used were as shown in the table below (Table 1). After curing at 80 °C for 24 hours, the compressive strengths of the geopolymerised mixtures were measured. The results are also shown in Table 1.

TABLE 1

| | Compressive |
|---|---|
| Binder | Strength (MPa) |
| 100 wt. % Class F Fly Ash | 17.3 |
| 85 wt. % Class F Fly Ash/15 wt. % S-Type Lime | 30.5 |
| 70 wt. % Class F Fly Ash/30 wt. % S-Type Lime | 26.3 |

Note:
The S-type lime comprises 51.8% CaO, 45.6% MgO, 0.8% SiO₂ and 0.9% Al₂O₃
Class F Fly Ash comprises 58.5 weight % SiO₂, 6.4 weight % CaO, 23.4 weight % Al₂O₃ and 1.9 weight % MgO.

### Comparative Example 2

In this Comparative Example, fly ash mortar compositions were formed by mixing 600 g of concrete sand, 400 g binder, 135 g of 10M sodium hydroxide, 25 g of add water and 10 g of a 1:1 organic-plasticizer:water mixture. The binder compositions used were as shown in Table 2 below. After curing at 80 °C for 17 hours, the compressive strengths of the geopolymerised mixtures were measured. The results are also shown in Table 2 below.

TABLE 2

| | Compressive |
|---|---|
| Binder | Strength (MPa) |
| 100 wt. % Class F Fly Ash | 14.9 |
| 90 wt. % Class F Fly Ash/10 wt. % Gypsum | 16.2 |
| 85 wt. % Class F Fly Ash/15 wt. % Gypsum | 12.3 |
| 80 wt. % Class F Fly Ash/20 wt. % Gypsum | not set after 17 |
| | hours of curing |
| 85 wt. % Class F Fly Ash/15 wt. % CaCO₃ | 10.0 |

Note:
The Class F Fly Ash employed in this Example comprises 58.5 weight % SiO₂, 6.4 weight % CaO, 23.4 weight % Al₂O₃ and 1.9 weight % MgO.

### Example 3

In this Example, fly ash mortar compositions were formed by mixing 200 g of concrete sand, 199.5 g binder and 45 g of 10M sodium hydroxide. The binder compositions used were as shown in the table below (Table 3). After curing at 80 °C for 40 hours, the compressive strengths of the geopolymerised mixtures were measured. The results are also shown in Table 3.

TABLE 3

| | Compressive |
|---|---|
| Binder | Strength (MPa) |
| 100 wt. % Unbeneficiated Fly Ash | 1.3 |
| 90 wt. % Unbeneficiated Fly Ash/ | 7.0 |
| 10 wt. % S-type lime | |

Note:
S-type lime comprises 51.8% CaO, 45.6% MgO, 0.8% SiO₂ and 0.9% Al₂O₃
The unbeneficiated fly ash used in this Example comprises 57.2 weight % SiO₂, 4.5 weight % CaO, 23.2 weight % Al₂O₃ and 2.2 weight % MgO.

### Example 4

In this Example, fly ash mortar compositions were formed by mixing 600 g of concrete sand, 400 g binder and 135 g of 10M sodium hydroxide, 10 g of a 1:1 mixture of plasticizer and water, and 25 g of add water. The binder compositions used were as shown in the table below (Table 4). After curing at 80 °C for 19 hours, the compressive strengths of the geopolymerised mixtures were measured. The results are also shown in Table 4.

TABLE 4

| | Compressive |
|---|---|
| Binder | Strength (MPa) |
| 100 wt. % Class F Fly Ash | 17.9 |
| 85 wt. % Class F Fly Ash/15 wt. % Mg(OH)₂ | 21.2 |
| 85 wt. % Class F Fly Ash/15 wt. % of a 1:1 | 24.8 |
| mixture of Mg(OH)₂ and Ca(OH)₂ | |

Note:
The Class F Fly Ash employed in this Example comprises 58.5 weight % SiO₂, 6.4 weight % CaO, 23.4 weight % Al₂O₃ and 1.9 weight % MgO.

### Example 5

In this Example, fly ash mortar compositions were formed by mixing 1200 g of concrete sand, 800 g binder and 270 g of 10M sodium hydroxide, 20 g of a 1:1 mixture of an organic plasticizer and water, and 50 g of additional water. The binder compositions used were as shown in the table below (Table 5). After curing at 80 °C for 19 hours, the compressive strengths of the geopolymerised mixtures were measured. The results are also shown in Table 5.

TABLE 5

| | Compressive |
|---|---|
| Binder | Strength (MPa) |
| 85 wt. % Class F Fly Ash/15 wt. % S-type | 32.8 |
| lime | |
| 85 wt. % Class F Fly Ash/15 wt. % of a 1:1 | 19.2 |
| mixture of Mg(OH)₂ and Ca(OH)₂ | |
| 85 wt. % Class F Fly Ash/15 wt. % of a 1:3 | 22.0 |
| mixture of Mg(OH)₂ and Ca(OH)₂ | |
| 85 wt. % Class F Fly Ash/15 wt. % of a 3:1 | 20.0 |
| mixture of Mg(OH)₂ and Ca(OH)₂ | |

Note:
S-type lime comprises 51.8% CaO, 45.6% MgO, 0.8% SiO₂ and 0.9% Al₂O₃
The Class F Fly Ash employed in this Example comprises 58.5 weight % SiO₂, 6.4 weight % CaO, 23.4 weight % Al₂O₃ and 1.9 weight % MgO.

### Example 6

In this Example, geopolymerisation mixtures comprising binder, sodium hydroxide and water were formed using the binders shown in Table 6 below. The compressive strengths of the geopolymerised mixtures were determined and reported in Table 6.

TABLE 6

| Binder | Compressive Strength (MPa) |
|---|---|
| 100 wt. % Class F Fly Ash | 27.0 |
| 88 wt. % Class F Fly Ash/ | 39.3 |
| 12 wt. % S-type lime | |
| 85 wt. % Class F Fly Ash/ | 39.3 |
| 15 wt. % of a Class C Fly Ash | |
| 100 wt. % Class C Fly Ash | 41.0 |

Note:
S-type lime comprises 51.8% CaO, 45.6% MgO, 0.8% SiO₂ and 0.9% Al₂O₃
The Class F Fly Ash employed in this Example comprises 58.5 weight % SiO₂, 6.4 weight % CaO, 23.4 weight % Al₂O₃ and 1.9 weight % MgO.

### Example 7

In this Example, fly ash mortar compositions were formed by mixing 1200 g of concrete sand, 800 g binder and 270 g of 10M sodium hydroxide, 20 g of a 1:1 mixture of an organic plasticizer and water, and 40 g of additional water. The binder compositions used were as shown in the table below (Table 7). After curing at 80 °C for 20 hours, the compressive strengths of the geopolymerised mixtures were measured. The results are also shown in Table 7.

TABLE 7

| Binder | Compressive Strength (MPa) |
|---|---|
| 100 wt. % Class F Fly Ash | 25.9 |
| 95 wt. % Class F Fly Ash/5 wt. % Class | 28.7 |
| C Fly Ash | |
| 90 wt. % Class F Fly Ash/10 wt. % of a | 34.4 |
| Class C Fly Ash | |
| 85 wt. % Class F Fly Ash/15 wt. % of a | 41.2 |
| Class C Fly Ash | |
| 75 wt. % Class F Fly Ash/25 wt. % of a | 40.7 |
| Class C Fly Ash | |

Note:
The Class F Fly Ash employed in this Example comprises 58.5 weight % SiO₂, 6.4 weight % CaO, 23.4 weight % Al₂O₃ and 1.9 weight % MgO.

### Example 8

In this Example, fly ash mortar compositions geopolymerisation mixtures comprising binder, sodium hydroxide and water were formed using the binders shown in Table 8 below. After curing at 80 °C for 24 hours, the compressive strengths of the geopolymerised mixtures were measured. The compressive strengths of the geopolymerised mixtures were determined and reported in Table 8.

TABLE 8

| Binder | Compressive Strength (MPa) |
|---|---|
| 100 wt. % Unbeneficiated Fly Ash (Gale | 3.5 |
| Common) | |
| 89 wt. % Unbeneficiated Fly Ash (Gale | 22.4 |
| Common)/11 wt. % Class C Fly Ash | |
| 89 wt. % Unbeneficiated Fly Ash (Gale | 17.7 |
| Common)/11 wt. % GGBFS | |

Note:
The unbeneficiated fly ash in this Example comprises 56.2 weight % SiO₂, 3.4 weight % CaO, 25.0 weight % Al₂O₃ and 2.7 weight % MgO.

### Example 9

In this Example, fly ash mortar compositions were formed by mixing 1200 g of concrete sand, 800 g binder and 270 g of 10M sodium hydroxide, 20 g of a 1:1 mixture of an organic plasticizer and water, and 40 g of add water. The binder compositions used were as shown in the table below (Table 9). After curing at 80 °C for 20 hours, the compressive strengths of the geopolymerised mixtures were measured. The results are also shown in Table 9.

TABLE 9

| Binder | Compressive Strength (MPa) |
|---|---|
| 100 wt. % Class F Fly Ash | 25.6 |
| 90 wt. % Class F Fly Ash/ | 35.9 |
| 10 wt. % GGBFS | |
| 85 wt. % Class F Fly Ash/ | 40.1 |
| 15 wt. % GGBFS | |
| 80 wt. % Class F Fly Ash/ | 36.8 |
| 20 wt. % GGBFS | |

Note:
The Class F Fly Ash employed in this Example comprises 58.5 weight % SiO₂, 6.4 weight % CaO, 23.4 weight % Al₂O₃ and 1.9 weight % MgO.

### Example 10

In this Example, fly ash mortar compositions were formed by mixing 600 g of concrete sand, 490 g binder and 38.4 g of alkali metal hydroxide activator, 8 g of a 1:1 mixture of an organic plasticizer and water, and 47 g of added water. The binder compositions used were as shown in the table below (Table 10). After curing at 80 °C for 25 hours, the compressive strengths of the geopolymerised mixtures were measured. The results are also shown in Table 10.

TABLE 10

| Binder | Compressive Strength (MPa) |
|---|---|
| 100% Unbeneficiated Fly Ash* | 11.1 |
| 85 wt. % Unbeneficiated Fly Ash/ | 24.1 |
| 15 wt. % GGBFS | |
| 85 wt. % Unbeneficiated Fly Ash/ | 26.5 |
| 15 wt. % Class C Fly Ash | |
| 85 wt. % Unbeneficiated Fly Ash/ | 23.5 |
| 15 wt. % S-type Lime | |

*576 g binder, 26.9 g added water
The unbeneficiated fly ash in this Example comprises 57.2 weight % SiO₂, 4.5 weight % CaO, 23.2 weight % Al₂O₃ and 2.2 weight % MgO

### Example 11

In this Example, fly ash mortar compositions were formed by mixing 600 g of concrete sand, 400 g binder and 38 g alkali metal hydroxide activator, 16 g of a 1:1 mixture of an organic plasticizer and water, and 75 g of added water. The binder compositions used were as shown in the table below (Table 11). The amount of sodium hydroxide activator used in sample C was 10% less than that used in samples A and B, respectively. The amount of sodium hydroxide activator used in sample D was 20% less that that used in samples A and B, respectively. After curing at 80 °C for 25 hours, the compressive strengths of the geopolymerised mixtures were measured. The results are also shown in Table 11.

It can be seen that CKD enhances the compressive strength of the material. The addition of CKD also allows desirable compressive strengths to be obtained at lower activator levels.

TABLE 11

| | Binder | Compressive Strength (MPa) |
|---|---|---|
| A | 100% Unbeneficiated Fly Ash | 21.7 |
| B | 85 wt. % Unbeneficiated Fly | 34.3 |
| | Ash/15 wt. % cement kiln | |
| | dust (CKD) | |
| C | 85 wt. % Unbeneficiated Fly | 32.8 |
| | Ash/15 wt. % CKD | |
| D | 85 wt. % Unbeneficiated Fly | 30.6. |
| | Ash/15 wt. % CKD | |

The fly ash in this Example comprises 58.7 weight % SiO₂, 4.1 weight % CaO, 23.0 weight % Al₂O₃ and 1.6 weight % MgO
CKD comprises 14.2 weight % SiO₂, 54.0 weight % CaO, and 5.0 weight % Al₂O₃

### Example 12

In this Example, compositions were formed by mixing 1215 g of coarse aggregate, 3368 g fine aggregate, 920 g binder and 93 g alkali metal hydroxide activator, 11 g of plasticizer and water, and 240-245 g of added water. The binder compositions used were as shown in the table below (Table 11). After dry casting and curing at 80 °C for 25 hours, the compressive strengths of the geopolymerised mixtures were measured. The results are also shown in Table 12.

TABLE 12
Strength

| | Binder | Compressive Strength (MPa) |
|---|---|---|
| A | 100% Class F Fly Ash | 20 |
| B | 85 wt. % Class F Fly Ash/15 | 34.2 |
| | wt. % cement kiln dust (CKD) | |
| C | 85 wt. % Class F Fly Ash/15 | 40.5 |
| | wt. % Class C Fly ash | |
| D | 85 wt. % Class F Fly Ash/15 | 37.3 |
| | wt. % S-type lime | |

The Class F Fly Ash employed in this Example comprises 58.5 weight % SiO₂, 6.4 weight % CaO, 23.4 weight % Al₂O₃ and 1.9 weight % MgO
The Class F Fly Ash employed in this Example comprises 38.1 weight % SiO₂, 23.5 weight % CaO, 19.8 weight % Al₂O₃ and 5.7 weight % MgO
S-type lime comprises 51.8% CaO, 45.6% MgO, 0.8% SiO₂ and 0.9% Al₂O₃

What is claimed is:

1. A geopolymerisation mixture comprising
fly ash,
an alkali metal hydroxide, and
a strength-enhancing additive comprising (i) calcium oxide and/or calcium hydroxide, and/or (ii) magnesium oxide and/or magnesium hydroxide
wherein the strength-enhancing additive is present in an amount of 5 to 30 weight % based on the total weight of fly ash and strength-enhancing additive in the geopolymerisation mixture.

2. A geopolymerisation mixture as claimed in claim 1, wherein the fly ash comprises calcium oxide in an amount of 18 weight % or less, preferably 15 weight % or less, more preferably 10 weight % or less.

3. A geopolymerisation mixture as claimed in claim 1, wherein the strength-enhancing additive comprises calcium oxide and at least one of silica, alumina and magnesium oxide, said calcium oxide being present in an amount of at least 30 weight %, preferably 30 to 70 weight %, based on the total weight of the strength-enhancing additive.

4. A geopolymerisation mixture as claimed in claim 3, wherein the strength-enhancing additive comprises silica and, optionally, alumina, said alumina being present in an amount of 0 to 10 weight % based on the total weight of the strength enhancing additive.

5. A geopolymerisation mixture as claimed in claim 4, wherein silica is present in an amount of 0.5 to 40 weight % of the total weight of the strength enhancing additive.

6. A geopolymerisation mixture as claimed in claim 1, wherein the fly ash is Class F fly ash or non-conforming fly ash.

7. A geopolymerisation mixture as claimed in claim 1, wherein the strength-enhancing additive comprises (i) calcium oxide and/or hydroxide and (ii) magnesium oxide and/or hydroxide.

8. A geopolymerisation mixture as claimed in claim 1, wherein the strength-enhancing additive is selected from S-type lime, Class C fly ash, cement kiln dust, Portland cement, ground granulated blast furnace slag (GGBFS) and mixtures thereof.

9. A geopolymerisation mixture as claimed in claim 1, which comprises 10 to 20 weight %, preferably 11 to 18 weight % of the strength-enhancing additive based on the total weight of fly ash and strength-enhancing additive in the geopolymerisation mixture.

10. A geopolymerisation obtainable by mixing fly ash, an alkali metal hydroxide, and a strength-enhancing additive comprising (i) calcium oxide and/or calcium hydroxide, and/or (ii) magnesium oxide and/or magnesium hydroxide together, wherein the strength-enhancing additive is present in an amount of 5 to 30 weight % based on the total weight of fly ash and strength-enhancing additive in the geopolymerisation mixture.

11. A geopolymerisation mixture as claimed in claim 1, which further comprises aggregate.

12. A geopolymerisation mixture as claimed in claim 11, wherein the aggregate is sand and/or gravel.

13. A process for forming a construction material, said process comprising geopolymerising a mixture as claimed in claim 1, and curing the mixture, preferably in a dry cast process.

14. A process as claimed in claim 13, wherein curing is performed at a temperature of 20 to 150 °C.

15. A process as claimed in claim 13, wherein the mixture is moulded into a construction article prior to curing

16. A process as claimed in claim 15, wherein the mixture is cast or moulded into a block, paver, pipe, vault, slab or other useable construction article.

17. (canceled)
